(19) United States
(12) Patent Application Publication
(10) Pub. No.: US 2025/0108719 A1
(43) Pub. Date: Apr. 3, 2025

(54) EV CHARGING APPARATUS AND METHOD FOR OPERATING THE SAME

(71) Applicant: TMEIC Corporation, Tokyo (JP)

(72) Inventor: Xiangguo WANG, Chuo-ku, Tokyo (JP)

(73) Assignee: TMEIC Corporation, Tokyo (JP)

(21) Appl. No.: 18/725,819

(22) PCT Filed: Aug. 31, 2022
(86) PCT No.: PCT/JP2022/032786

§ 371 Date: Jul. 1, 2024

(51) Int. Cl. B60L 53/63; B60L 53/22; B60L 53/67; B60L 55/00; H02J 3/32

(52) U.S. Cl. CPC B60L 53/63; B60L 53/22; B60L 53/67; B60L 55/00; H02J 3/322

(57) ABSTRACT

An EV charging apparatus includes: a plurality of charging stations respectively connected detachably with EVs, the plurality of charging stations being configured to charge power storage devices mounted in the EVs when connected; a plurality of power supply circuits configured to convert power supplied from a power system side into direct current power compatible with the EVs, and to supply the direct current power after the conversion respectively to the plurality of charging stations; a charging/discharging station connected detachably with the EV, the charging/discharging station being configured to charge and discharge the power storage device mounted in the EV when connected; and a bidirectional converter configured to perform power conversion in two directions, the two directions being a direction of charging the power storage device of the EV connected to the charging/discharging station, and a direction of discharging the power storage device of the EV connected to the charging/discharging station.

### FIELD

Embodiments described herein relate generally to an EV charging apparatus and a method for operating the same.

### BACKGROUND ART

A charging apparatus for an EV (electric vehicle) includes a charging station. The charging station is detachably connected with the EV, and charges a power storage device mounted in the EV.

Such a charging apparatus includes multiple charging stations. A charging apparatus that includes multiple charging stations can simultaneously charge multiple EVs, and can improve the convenience of the EVs. Charging apparatuses that include multiple charging stations are installed in facilities of high public use such as, for example, expressway service areas and rest stops, shopping malls, etc.

In a charging apparatus including multiple charging stations, it is necessary to set the contract demand with an electric company or the like to be not less than the total capacity of the multiple charging stations. For example, when one hundred 6 kW-capacity charging stations are installed, it is necessary to set the contract demand to be not less than 600 kW. Therefore, contract demand prices soar for a charging apparatus that includes multiple charging stations. Also, a large amount of power is necessary when multiple EVs are simultaneously charged, which places a large load on the power system.

Therefore, it has been proposed to utilize a stationary storage battery in a charging apparatus including multiple charging stations. For example, the storage battery is precharged when the power demand is low (when the number of EVs to be charged is low), so that power can be supplied to the charging stations from the storage battery when the power demand is high (when the number of EVs to be charged is high). As a result, the contract demand can be reduced according to the capacity of the storage battery; and the load of the power system when the power demand of the multiple charging stations is high can be reduced.

However, there is a possibility that the capacity of a stationary storage battery may be insufficient when the power demand remains high for a long period of time, etc. To suppress the occurrence of insufficient capacity, it also may be considered to increase the storage battery capacity beforehand; however, when the storage battery capacity is increased, there is a risk that the initial cost of the charging apparatus may be undesirably high.

Also, there is a possibility that stationary storage batteries may fall under, for example, hazardous materials such as Class 4.2 petroleum products, etc. When the storage batteries fall under hazardous materials, appropriate measures must be taken in the installation, operation, management, and the like of the storage batteries; and such measures also may increase the cost.

It is therefore desirable to be able to reduce the contract demand of an EV charging apparatus including multiple charging stations with a simpler configuration.

### CITATION LIST

### Patent Literature

### Patent Literature 1

JP-A 2021-93788 (Kokai)

### SUMMARY OF INVENTION

### Problem to be Solved by the Invention

Embodiments of the invention provide an EV charging apparatus and a method for operating an EV charging apparatus in which multiple charging stations are included, and the contract demand can be reduced with a simpler configuration.

### Solution to Problem

According to an embodiment of the invention, an EV charging apparatus is provided, the EV charging apparatus includes: a plurality of charging stations respectively connected detachably with EVs, the plurality of charging stations being configured to charge power storage devices mounted in the EVs when connected; a plurality of power supply circuits configured to convert power supplied from a power system side into direct current power compatible with the EVs, and to supply the direct current power after the conversion respectively to the plurality of charging stations; a charging/discharging station connected detachably with the EV, the charging/discharging station being configured to charge and discharge the power storage device mounted in the EV when connected; a bidirectional converter configured to perform power conversion in two directions, the two directions being a direction of charging the power storage device of the EV connected to the charging/discharging station, and a direction of discharging the power storage device of the EV connected to the charging/discharging station, the bidirectional converter being configured to convert, in the power conversion in the charging direction, the power supplied from the power system side into the direct current power compatible with the EVs, and supply the direct current power after the conversion to the charging/discharging station, and convert, in the power conversion in the discharging direction, direct current power supplied from the power storage device of the EV connected to the charging/discharging station into power compatible with the plurality of power supply circuits, and supply the power after the conversion to the plurality of power supply circuits.

### Advantageous Effects of Invention

According to embodiments of the invention, an EV charging apparatus and a method for operating an EV charging apparatus in which multiple charging stations are included, and the contract demand can be reduced with a simpler configuration are provided.

### BRIEF DESCRIPTION OF DRAWINGS

FIG. 1 is a block diagram schematically illustrating an EV charging apparatus according to an embodiment.

FIG. 2 is a flowchart schematically illustrating an example of a method for operating the EV charging apparatus according to the embodiment.

FIG. 3 is a flowchart schematically illustrating another example of the method for operating the EV charging apparatus according to the embodiment.

FIG. 4 is a block diagram schematically illustrating a modification of the EV charging apparatus according to the embodiment.

### DESCRIPTION OF EMBODIMENTS

Embodiments will now be described with reference to the drawings.

The drawings are schematic and conceptual; and the relationships between the thicknesses and widths of portions, the proportions of sizes among portions, etc., are not necessarily the same as the actual values. Also, the dimensions and proportions may be illustrated differently among drawings, even for identical portions.

In the specification and drawings, components similar to those described previously or illustrated in an antecedent drawing are marked with the same reference numerals; and a detailed description is omitted as appropriate.

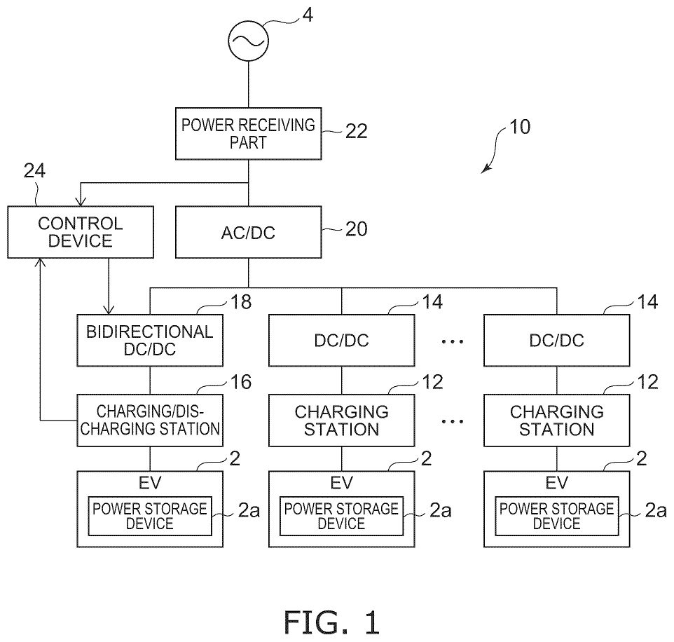

FIG. 1 is a block diagram schematically illustrating an EV charging apparatus according to an embodiment.

As illustrated in FIG. 1, the EV charging apparatus 10 includes multiple charging stations 12, multiple DC/DC power supply circuits 14 (power supply circuits), a charging/discharging station 16, a bidirectional DC/DC converter 18 (a bidirectional converter), an AC/DC power supply circuit 20, a power receiving part 22, and a control device 24.

The multiple charging stations 12 are used to connect with EVs 2. The multiple charging stations 12 are respectively connected detachably with the EVs 2, and charge power storage devices 2a mounted in the connected EVs 2. In other words, the charging station 12 is a charging plug that is detachably connected to a charging socket provided in the EV 2.

The EV charging apparatus 10 is connected with the EV 2 via one of the multiple charging stations 12. Accordingly, the EV charging apparatus 10 can simultaneously charge a number of EVs 2 corresponding to the number of the charging stations 12.

The EV 2 may be a BEV (Battery Electric Vehicle) having only a motor as a power source, or a PHEV (Plug-in Hybrid Electric Vehicle) having a motor and an engine as power sources, etc. The EV 2 may be any vehicle that includes a power storage device 2a, can travel based on DC power stored in the power storage device 2a, and can charge the power storage device 2a with an external power supply. The power storage device 2a of the EV 2 is, for example, a storage battery, a capacitor, etc. The power storage device 2a may be any device that can store DC power.

The EV charging apparatus 10 is connected to a power system 4. The EV charging apparatus 10 charges the EV 2 based on power supplied from the power system 4. The power of the power system 4 is AC power. However, the power of the power system 4 is not limited to AC power and may be DC power, etc.

The power receiving part 22 is connected with the power system 4, and receives a supply of power from the power system 4. The power receiving part 22 includes, for example, a transformer, a circuit breaker, etc. For example, the power receiving part 22 inputs the power supplied from the power system 4 to the AC/DC power supply circuit 20. The configuration of the power receiving part 22 may be any configuration that can receive the supply of the power from the power system 4 and input the power to the AC/DC power supply circuit 20, etc.

The AC/DC power supply circuit 20 is, for example, an AC/DC converter. For example, the AC/DC power supply circuit 20 is connected to the power receiving part 22, and converts AC power supplied from the power system 4 via the power receiving part 22 into DC power. The AC/DC power supply circuit 20 may be omitted when, for example, the power of the power system 4 is DC power, etc. The AC/DC power supply circuit 20 is provided as necessary, and is omissible.

The multiple DC/DC power supply circuits 14 convert the power supplied from the power system 4 side into DC power compatible with the EVs 2, and supplies the DC power after the conversion respectively to the multiple charging stations 12. The multiple charging stations 12 charge the power storage devices 2a mounted in the connected EVs 2 based on the DC power supplied respectively from the multiple DC/DC power supply circuits 14.

The multiple DC/DC power supply circuits 14 are, for example, DC/DC converters. The multiple DC/DC power supply circuits 14 convert the DC power supplied from the AC/DC power supply circuit 20 into another DC power compatible with the EVs 2. The rated voltages of the multiple DC/DC power supply circuits 14 are, for example, not less than the total voltage of the power storage device 2a of the EV 2. The total voltage of the power storage device 2a of the EV 2 is, for example, about 400 V. In such a case, the rated voltages of the multiple DC/DC power supply circuits 14 are set to be not less than 400 V. The rated voltages of the multiple DC/DC power supply circuits 14 may not always be equal. The configurations of the multiple DC/DC power supply circuits 14 are not limited to those described above, and may be any configuration that can supply DC power compatible with the power storage device 2a of the EV 2 and appropriately charge the power storage device 2a of the EV 2.

The multiple DC/DC power supply circuits 14 are provided respectively for the multiple charging stations 12. In other words, the multiple DC/DC power supply circuits 14 are provided to correspond respectively to the multiple charging stations 12. Each charging station 12 charges the EV 2 based on the DC power supplied from the corresponding DC/DC power supply circuit 14. In such a case, the number of the multiple DC/DC power supply circuits 14 is equal to the number of the multiple charging stations 12.

The EV charging apparatus 10 may include, for example, a switching device that selectively switches the connections between the multiple DC/DC power supply circuits 14 and the multiple charging stations 12. In other words, the output of each of the multiple DC/DC power supply circuits 14 may be able to be selectively supplied to each of the multiple charging stations 12.

When the switching device is included, for example, when the EV 2 is connected to any charging station 12 among the multiple charging stations 12, the outputs of each of the multiple DC/DC power supply circuits 14 can be supplied to the charging station 12 connected with the EV 2; and the utilization efficiency of the multiple DC/DC power supply circuits 14 can be increased.

When the switching device is included, the number of the multiple DC/DC power supply circuits 14 may be different from the number of the multiple charging stations 12. The number of the multiple DC/DC power supply circuits 14 may not always be equal to the number of the multiple charging stations 12.

The charging/discharging station 16 is used to connect with the EV 2. By being detachably connected with the EV 2, the charging/discharging station 16 charges and discharges the power storage device 2a mounted in the connected EV 2. In other words, the charging/discharging station 16 is a charging/discharging plug connected detachably to a charging/discharging socket provided in the EV 2.

The charging/discharging station 16 has a function of communicating with the connected EV 2. For example, the charging/discharging station 16 communicates with the ECU (Electronic Control Unit) of the EV 2. By communicating with the connected EV 2, the charging/discharging station 16 acquires information related to the charge amount of the power storage device 2a from the EV 2. The information related to the charge amount of the power storage device 2a is, for example, information of the optimal current value (the current indication value) corresponding to the state of the power storage device 2a. However, the information related to the charge amount of the power storage device 2a is not limited thereto, and may be any information that makes it possible to ascertain the charge amount of the power storage device 2a at the charging/discharging station 16 side. The information related to the charge amount of the power storage device 2a may be, for example, information of the voltage value of the power storage device 2a, etc.

The bidirectional DC/DC converter 18 performs power conversion in the two directions of the direction of charging the power storage device 2a of the EV 2 connected to the charging/discharging station 16, and the direction of discharging the power storage device 2a of the EV 2 connected to the charging/discharging station 16. The bidirectional DC/DC converter 18 is, for example, a DC/DC converter that can perform power conversion in two directions.

The bidirectional DC/DC converter 18 converts the power supplied from the power system 4 side into DC power compatible with the EV 2, and supplies the DC power after the conversion to the charging/discharging station 16. For example, the bidirectional DC/DC converter 18 converts the DC power supplied from the AC/DC power supply circuit 20 into another DC power that is compatible with the EV 2, and supplies the DC power after the conversion to the charging/discharging station 16.

The charging/discharging station 16 charges the power storage device 2a mounted in the connected EV 2 based on the DC power supplied from the bidirectional DC/DC converter 18. For example, the charging/discharging station 16 charges the power storage device 2a mounted in the connected EV 2 based on the DC power supplied from the bidirectional DC/DC converter 18 and the information acquired from the EV 2. For example, the charging/discharging station 16 charges the power storage device 2a mounted in the connected EV 2 at the optimal current value acquired from the EV 2. For example, the information acquired from the EV 2 is transmitted to the bidirectional DC/DC converter 18; and optimal charging that corresponds to the information acquired from the EV 2 is performed by supplying power corresponding to the acquired information from the bidirectional DC/DC converter 18 to the charging/discharging station 16.

Also, the bidirectional DC/DC converter 18 converts the DC power supplied from the power storage device 2a of the EV 2 connected to the charging/discharging station 16 into power compatible with the multiple DC/DC power supply circuits 14, and supplies the power after the conversion to the multiple DC/DC power supply circuits 14. For example, the bidirectional DC/DC converter 18 converts the DC power supplied from the power storage device 2a of the EV 2 connected to the charging/discharging station 16 into another DC power compatible with the input side (the AC/DC power supply circuit 20 side) of the multiple DC/DC power supply circuits 14, and supplies the DC power after the conversion to the multiple DC/DC power supply circuits 14.

For example, the bidirectional DC/DC converter 18 supplies the DC power after the conversion to any of the multiple DC/DC power supply circuits 14. For example, the bidirectional DC/DC converter 18 supplies the DC power after the conversion to the power supply path between the AC/DC power supply circuit 20 and the multiple DC/DC power supply circuits 14. In other words, the bidirectional DC/DC converter 18 supplies to the power supply path at the input side of the multiple DC/DC power supply circuits 14. As a result, the power that is output from the bidirectional DC/DC converter 18 is supplied to any of the DC/DC power supply circuits 14 among the multiple DC/DC power supply circuits 14 that need a supply of power.

Thus, in the EV charging apparatus 10, the DC power that is stored in the power storage device 2a of the EV 2 connected to the charging/discharging station 16 can be supplied to the multiple DC/DC power supply circuits 14. As a result, in the EV charging apparatus 10, the contract demand can be reduced according to the capacities of the charging/discharging station 16 and the bidirectional DC/DC converter 18.

The capacity of the charging station 12 is, for example, 6 kW. The capacity of the charging/discharging station 16 is, for example, 50 KW. The charging/discharging station 16 is, for example, a quick charger. The capacity of the charging/discharging station 16 is, for example, greater than the capacity of the charging station 12. Accordingly, the charging/discharging station 16 can appropriately supply the power to the multiple charging stations 12 even when the number of charging/discharging stations 16 is less than the number of the multiple charging stations 12. The example shows one charging/discharging station 16 and one bidirectional DC/DC converter 18. The numbers of the charging/discharging stations 16 and the bidirectional DC/DC converters 18 are not limited to one, and may be any number. Also, the capacity of the charging/discharging station 16 may not always be greater than the capacity of the charging station 12. The charging station 12 may be the charging/discharging station. It is sufficient for the charging station 12 to have at least the charging function, and a discharging function also may be included. The charging station 12 may be, for example, a quick charger similar to the charging/discharging station 16, etc.

For example, suppose that one hundred 6-kW capacity charging stations 12 are installed, and four 50-kW charging/discharging stations 16 are installed. In the case of only the charging station 12, it would be necessary to set the contract demand to be not less than 600 KW (6 kW×100). In contrast, when the charging/discharging station 16 is included, by connecting the multiple EVs 2 to the multiple charging stations 12 and simultaneously charging the multiple EVs 2, the power that is stored in the EV 2 connected to the charging/discharging station 16 can be supplied to the multiple charging stations 12 when the power received by the multiple charging stations 12 is increased. In other words, when the supply power of the multiple charging stations 12 is about to exceed the contract demand, the power amount that exceeds the contract demand can be supplied from the charging/discharging station 16 side to the multiple charging stations 12. In the EV charging apparatus 10, the contract demand can be reduced thereby. For example, when four charging/discharging stations 16 are included as described above, the contract demand can be suppressed by 200 kW (50 kW×4) corresponding to the capacity of the charging/discharging stations 16; and the contract demand can be 400 kW or more.

The contract demand of the EV charging apparatus 10 is set to be not less than the value of the capacity of the charging/discharging stations 16 subtracted from the total capacity of the multiple charging stations 12, but less than the total capacity of the multiple charging stations 12. When multiple charging/discharging stations 16 are included, the contract demand of the EV charging apparatus 10 is set to be not less than the value of the total capacity of the multiple charging/discharging stations 16 subtracted from the total capacity of the multiple charging stations 12. For example, in the example above, the contract demand of the EV charging apparatus 10 is set to be not less than 400 kW but less than 600 kW. As a result, for example, by supplying the power from the charging/discharging station 16 side, the supply power of the multiple charging stations 12 can be prevented from undesirably exceeding the contract demand even when charging all of the multiple charging stations 12 with a suppressed contract demand.

The control device 24 controls the operation of the bidirectional DC/DC converter 18. The control device 24 acquires information related to the charge amount of the power storage device 2a connected to the charging/discharging station 16. For example, the control device 24 acquires the information related to the charge amount of the power storage device 2a from the charging/discharging station 16 by communicating with the charging/discharging station 16. For example, the control device 24 may acquire the information related to the charge amount of the power storage device 2a from the bidirectional DC/DC converter 18 by communicating with the bidirectional DC/DC converter 18. The method for acquiring the information related to the charge amount of the power storage device 2a may be any method that can appropriately acquire the information.

Also, the control device 24 acquires information of the amount of electricity received from the power system 4. For example, the control device 24 acquires the information of the amount of electricity received from the power system 4 from a wattmeter or the like, which is not illustrated. For example, the control device 24 may communicate with the multiple charging stations 12 and the charging/discharging station 16 and acquire the information of the received electricity amount based on the operation status (whether or not charging is being performed) of the multiple charging stations 12 and the charging/discharging station 16. In other words, the control device 24 may acquire the information of the received electricity amount by calculating based on the total capacity of the charging stations 12 and charging/discharging station 16 when charging, etc. The method for acquiring the information of the received electricity amount may be any method that can appropriately acquire the information.

The control device 24 controls the operation of the conversion of the power by the bidirectional DC/DC converter 18 based on the information related to the charge amount of the power storage device 2a and the information of the amount of electricity received from the power system 4 that are acquired.

Based on the information of the amount of electricity received from the power system 4, the control device 24 operates the bidirectional DC/DC converter 18 in the charging direction to charge the power storage device 2a of the EV 2 connected to the charging/discharging station 16 when the supply power of the multiple charging stations 12 and the charging/discharging station 16 is less than the contract demand. More specifically, based on the information of the received electricity amount, the control device 24 operates the bidirectional DC/DC converter 18 in the charging direction when the supply power would be less than the contract demand even when the increase amount of the supply power accompanying the operation of the charging/discharging station 16 is added to the received electricity amount at that time.

Thus, the control device 24 charges the power storage device 2a of the EV 2 connected to the charging/discharging station 16 when there is an ample margin in the supply power of the multiple charging stations 12 and the charging/discharging station 16. As a result, preparations are made for when the power demand is increased by simultaneously charging the multiple EVs 2.

Based on the information related to the charge amount of the power storage device 2a, the control device 24 stops charging the power storage device 2a of the EV 2 connected to the charging/discharging station 16 when the charging of the power storage device 2a is completed.

Also, when the supply power of the multiple charging stations 12 is predicted to reach or exceed the contract demand based on the information of the amount of electricity received from the power system 4, the control device 24 operates the bidirectional DC/DC converter 18 in the discharging direction to supply the DC power stored in the power storage device 2a of the EV 2 connected to the charging/discharging station 16 to the multiple DC/DC power supply circuits 14 (the multiple charging stations 12). As a result, as described above, the supply power of the multiple charging stations 12 is prevented from undesirably exceeding the contract demand.

The control device 24 may be able to further control the operations of the multiple DC/DC power supply circuits 14. For example, it is considered that the DC power stored in the power storage device 2a of the EV 2 connected to the charging/discharging station 16 may undesirably become insufficient as the power is consumed in the state in which the supply power of the multiple charging stations 12 is not less than the contract demand. When the DC power stored in the power storage device 2a of the EV 2 connected to the charging/discharging station 16 becomes insufficient, the control device 24 may stop the supply of the power from the charging/discharging station 16 side, and may control the operations of the multiple DC/DC power supply circuits 14 so that the supply power of the multiple charging stations 12 is less than the contract demand.

For example, the control device 24 sets the supply power of the multiple charging stations 12 to be less than the contract demand by reducing the charging power of the multiple charging stations 12. For example, the control device 24 may cause the supply power of the multiple charging stations 12 to be less than the contract demand by causing one of the multiple charging stations 12 to wait for charging, and by sequentially starting the charging of the charging station 12 on standby when the charging of another charging station 12 is completed. As a result, the supply power of the multiple charging stations 12 can be more appropriately prevented from undesirably exceeding the contract demand.

For example, the EV charging apparatus 10 is installed at facilities of high public use such as expressway service areas and rest stops, shopping malls, etc. The EV 2 that is connected to the charging/discharging station 16 is, for example, a company car of the company managing the facility, a privately owned car of an employee of the management company, etc. The EV 2 that is connected to the charging/discharging station 16 is, for example, a dedicated EV used in the charging/discharging station 16 in the EV charging apparatus 10.

For example, the dedicated EV 2 that is connected to the charging/discharging station 16 is left in the state of being connected to the charging/discharging station 16 during the time that the charging/discharging station 16 is used (e.g., the business hours of the facility where the charging/discharging station 16 is installed). For example, when the dedicated EV 2 is a company car, the dedicated EV 2 may be constantly left in the state of being connected to the charging/discharging station 16 even after business hours. For example, when the dedicated EV 2 is a privately owned car of an employee, the employee comes to work in the EV 2 when coming to work before the start of business, connects the EV 2 to the charging/discharging station 16, and when leaving work after the end of business, detaches the charging/discharging station 16 from the EV 2 and returns home in the EV 2.

A customer or the like that utilizes the facility connects the EV 2 to one of the multiple charging stations 12, and charges the power storage device 2a of the EV 2. As a result, as described above, the dedicated EV 2 that is connected to the charging/discharging station 16 can be charged, and when the power demand increases, the power that is stored in the dedicated EV 2 connected to the charging/discharging station 16 can be supplied to the multiple DC/DC power supply circuits 14.

For example, the dedicated EV 2 may be connected to the charging/discharging station 16 and the power may be supplied from the charging/discharging station 16 side only when the power demand increases. The dedicated EV 2 may not always be left in the state of being connected to the charging/discharging station 16. The EV 2 that is connected to the charging/discharging station 16 may not always be a dedicated EV 2. For example, a patron of the facility or the like may be able to arbitrarily connect the patron's EV 2 to the charging/discharging station 16. For example, when the power demand is low, the EV 2 of the patron may be charged by the charging/discharging station 16. For example, patron EVs 2 that have high charge amounts may be able to cooperate for the supply of power when the power demand increases.

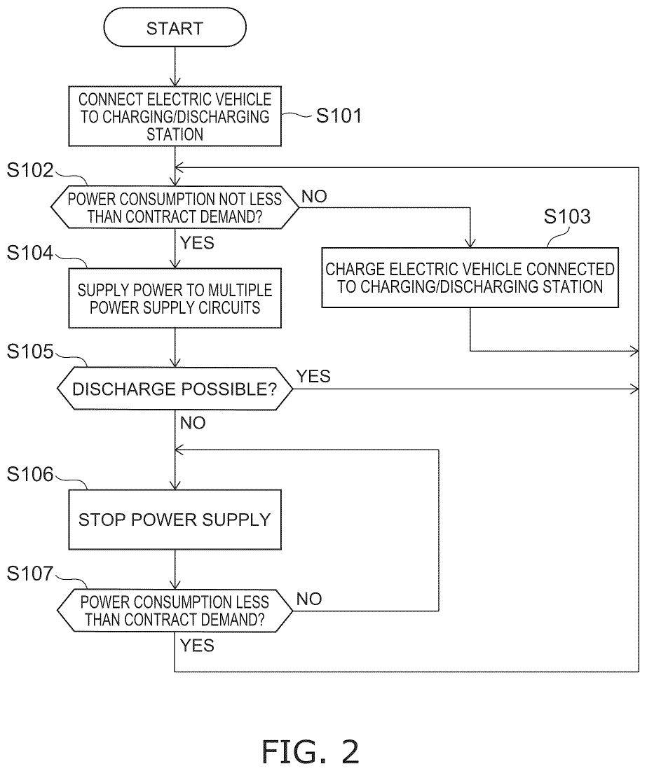

FIG. 2 is a flowchart schematically illustrating an example of a method for operating the EV charging apparatus according to the embodiment.

According to the method for operating the EV charging apparatus 10 as illustrated in FIG. 2, first, the EV 2 is connected to the charging/discharging station 16 (step S101 of FIG. 2).

After connecting the EV 2 to the charging/discharging station 16, it is determined whether or not the supply power of the multiple charging stations 12 and the charging/discharging station 16 is not less than a contract demand (step S102 of FIG. 2). For example, the determination of whether or not the supply power of the multiple charging stations 12 and the charging/discharging station 16 is not less than the contract demand is performed by the control device 24. However, this determination may be performed by, for example, a manager or the like of the EV charging apparatus 10 based on a measured value of a wattmeter, etc.

When the supply power of the multiple charging stations 12 and the charging/discharging station 16 is less than the contract demand, the power storage device 2a of the EV 2 connected to the charging/discharging station 16 is charged (step S103 of FIG. 2).

For example, the power storage device 2a of the EV 2 connected to the charging/discharging station 16 is charged by the bidirectional DC/DC converter 18 operating in the charging direction due to a control by the control device 24 that determined the supply power to be less than the contract demand. The control is not limited thereto; for example, the manager or the like of the EV charging apparatus 10 that determined the supply power to be less than the contract demand may operate the bidirectional DC/DC converter 18 in the charging direction to charge the power storage device 2a of the EV 2 connected to the charging/discharging station 16.

As a method of the manager or the like of the EV charging apparatus 10 controlling the operation of the bidirectional DC/DC converter 18, for example, it may be considered to include an operation part in the charging/discharging station 16 or the bidirectional DC/DC converter 18. The manager or the like of the EV charging apparatus 10 operates the bidirectional DC/DC converter 18 in the charging direction by operating the operation part. However, the method of the manager or the like of the EV charging apparatus 10 controlling the operation of the bidirectional DC/DC converter 18 is not limited to the method described above, and may be any method that can appropriately control the operation of the bidirectional DC/DC converter 18.

When the supply power of the multiple charging stations 12 and the charging/discharging station 16 is less than the contract demand, for example, the processing of steps S102 and S103 is repeated, and the power storage device 2a of the EV 2 connected to the charging/discharging station 16 is charged until the charging of the power storage device 2a of the EV 2 connected to the charging/discharging station 16 is completed.

On the other hand, when the supply power of the multiple charging stations 12 and the charging/discharging station 16 is determined to be not less than the contract demand in step S102, the DC power that is stored in the power storage device 2a of the EV 2 connected to the charging/discharging station 16 is supplied to the multiple DC/DC power supply circuits 14 (step S104 of FIG. 2).

For example, the supply of the power to the multiple DC/DC power supply circuits 14 is performed by the bidirectional DC/DC converter 18 being operated in the discharging direction by the control device 24 that determined the supply power to be not less than the contract demand. This is not limited thereto; for example, the manager or the like of the EV charging apparatus 10 that determined the supply power to be not less than the contract demand may operate the bidirectional DC/DC converter 18 in the discharging direction to supply power to the multiple DC/DC power supply circuits 14 based on the DC power stored in the power storage device 2a of the EV 2 connected to the charging/discharging station 16.

The timing of starting the supply of the power from the charging/discharging station 16 side may not always be at the timing that the supply power reaches or exceeds the contract demand. For example, the supply of the power from the charging/discharging station 16 side may be started when the supply power reaches or exceeds a prescribed threshold. Also, the EV 2 may be connected to the charging/discharging station 16 directly before starting the supply of the power from the charging/discharging station 16 side. For example, the EV 2 may be connected to the charging/discharging station 16 when the supply power reaches or exceeds a first threshold; and the supply of the power from the charging/discharging station 16 side may be started when the supply power reaches or exceeds a second threshold that is greater than the first threshold. The first threshold and the second threshold can be set arbitrarily. For example, it is favorable for the second threshold to be set to be not more than the contract demand.

After starting the supply of the power to the multiple DC/DC power supply circuits 14, it is determined whether or not the power storage device 2a of the EV 2 connected to the charging/discharging station 16 can discharge (step S105 of FIG. 2). In other words, it is determined whether or not the charge amount of the power storage device 2a of the EV 2 connected to the charging/discharging station 16 is not more than a prescribed value.

Determination of whether or not discharge is possible is performed by, for example, the control device 24 based on information related to the charge amount of the power storage device 2a. However, this determination may be performed by, for example, the manager or the like of the EV charging apparatus 10 based on the information related to the charge amount of the power storage device 2a, etc. For example, the information related to the charge amount of the power storage device 2a can be notified to the manager or the like of the EV charging apparatus 10 by displaying in a display part located in the charging/discharging station 16 and/or the bidirectional DC/DC converter 18, or by notifying to a portable terminal such as a smartphone or the like possessed by the manager or the like of the EV charging apparatus 10. The method of notifying the information related to the charge amount of the power storage device 2a to the manager or the like of the EV charging apparatus 10 may be any method that can appropriately notify the information to the manager or the like.

When it is determined that discharge is possible, the flow returns to the processing of step S102; and the power storage device 2a of the EV 2 connected to the charging/discharging station 16 is charged or discharged according to the supply power of the multiple charging stations 12 and the charging/discharging station 16.

On the other hand, when it is determined that discharge is impossible, the supply to the multiple DC/DC power supply circuits 14 of the power from the power storage device 2a of the EV 2 connected to the charging/discharging station 16 is stopped (step S106 of FIG. 2). The supply of the power may be stopped automatically by the control device 24, or may be stopped based on an operation of the manager or the like of the EV charging apparatus 10. Or, the charging/discharging station 16 and the bidirectional DC/DC converter 18 may automatically stop the discharge based on a discharge stop command from the EV 2, etc.

Also, when the supply of the power from the power storage device 2a of the EV 2 connected to the charging/discharging station 16 to the multiple DC/DC power supply circuits 14 is stopped, the operations of the multiple DC/DC power supply circuits 14 may control so that the supply power of the multiple charging stations 12 is less than the contract demand as described above.

After stopping the supply of the power from the power storage device 2a of the EV 2 connected to the charging/discharging station 16 to the multiple DC/DC power supply circuits 14, it is determined whether or not the supply power of the multiple charging stations 12 and the charging/discharging station 16 is less than the contract demand (step S107 of FIG. 2). When the operations of the multiple DC/DC power supply circuits 14 are controlled so that the supply power of the multiple charging stations 12 is less than the contract demand, the supply power that is determined here is the assumed supply power when the operations of the multiple DC/DC power supply circuits 14 are not controlled in such a manner.

When the supply power of the multiple charging stations 12 and the charging/discharging station 16 is not less than the contract demand, the state is continued in which the supply of the power from the power storage device 2a of the EV 2 connected to the charging/discharging station 16 to the multiple DC/DC power supply circuits 14 is stopped.

On the other hand, when the supply power of the multiple charging stations 12 and the charging/discharging station 16 is less than the contract demand, the flow returns to the processing of step S102; and the power storage device 2a of the EV 2 connected to the charging/discharging station 16 is charged.

Thus, the method for operating the EV charging apparatus 10 includes a process of connecting the EV 2 to the charging/discharging station 16 (e.g., step S101 of FIG. 2), and a process of preventing the supply power of the multiple charging stations 12 from undesirably exceeding the contract demand operating the bidirectional converter 18 in the discharging direction to supply the DC power stored in the power storage device 2a of the EV 2 connected to the charging/discharging station 16 to the multiple DC/DC power supply circuits 14 when the supply power of the multiple charging stations 12 reaches or exceeds the contract demand (e.g., step S104 of FIG. 2). The method for operating the EV charging apparatus 10 may be any method for operating that includes at least these two processes.

As described above, the EV charging apparatus 10 according to the embodiment includes the charging/discharging station 16 and the bidirectional DC/DC converter 18, and supplies the DC power stored in the power storage device 2a of the EV 2 connected to the charging/discharging station 16 to the multiple DC/DC power supply circuits 14 when the supply power of the multiple charging stations 12 and the charging/discharging station 16 reaches or exceeds the contract demand. As a result, as described above, the supply power of the multiple charging stations 12 can be prevented from undesirably exceeding the contract demand by supplying the power from the charging/discharging station 16 side even when the multiple charging stations 12 are simultaneously charged with a suppressed contract demand.

By reducing the contract demand, for example, the operating cost of the EV charging apparatus 10 can be suppressed. Also, by reducing the contract demand, for example, the load of the power system 4 can be suppressed even when the power demand of the multiple charging stations 12 increases.

For example, it has been proposed to suppress the contract demand by including a stationary storage battery in the EV charging apparatus and by supplying power from the stationary storage battery. However, there is a possibility that stationary storage batteries may undesirably fall under hazardous materials. When the storage batteries fall under hazardous materials, appropriate measures must be taken in the installation, operation, management, and the like of the storage batteries; and there is a risk that the cost of the EV charging apparatus may be increased.

In contrast, when the DC power that is stored in the power storage device 2a of the EV 2 connected to the charging/discharging station 16 can be supplied to the multiple DC/DC power supply circuits 14, special measures for the installation, operation, management, etc., of the EV 2 are unnecessary. As a result, in the EV charging apparatus 10 according to the embodiment, the contract demand can be reduced with a simpler configuration even when the multiple charging stations 12 are included.

In a system that uses a stationary storage battery, when changing the capacity of the storage battery, the storage battery itself must be interchanged, which is extremely time-consuming. In contrast, in the EV charging apparatus 10, the capacity of the power storage device 2a can be easily changed merely by connecting an EV 2 having a different capacity of the power storage device 2a to the charging/discharging station 16. For example, even when charging stations 12 are added, etc., the power storage capacity can be easily increased merely by interchanging the EV 2. Thus, in the EV charging apparatus 10, a system that corresponds to the necessary power storage capacity can be easily constructed.

Also, when the EV 2 is used, for example, the EV 2 for connecting to the charging/discharging station 16 only during periods of increased power demand (periods of increased patrons) can be rented, etc. As a result, for example, the initial cost, operating cost, etc., of the EV charging apparatus 10 also can be suppressed.

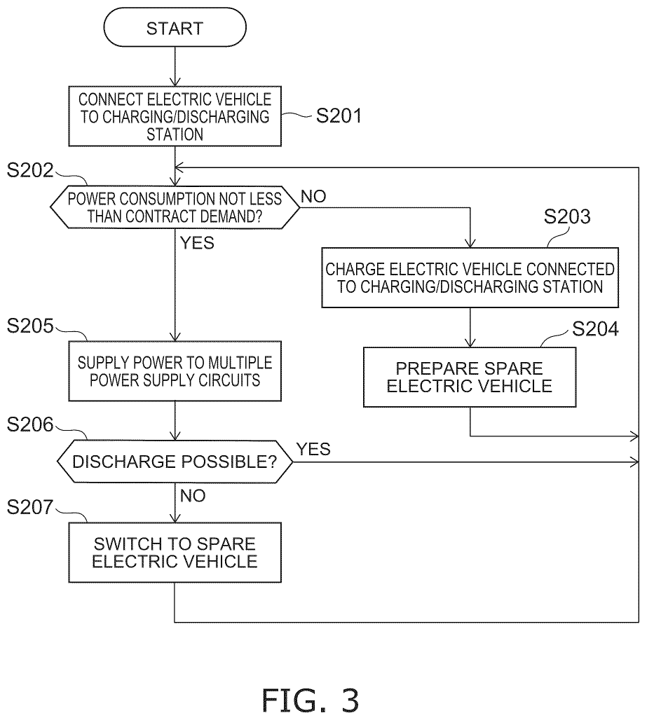

FIG. 3 is a flowchart schematically illustrating another example of the method for operating the EV charging apparatus according to the embodiment.

In FIG. 3, the processing of steps S201 to S203 is similar to the processing of steps S101 to S103 described with reference to FIG. 2; and a detailed description is therefore omitted.

In the example as illustrated in FIG. 3, the preparation of a spare EV 2 for connecting to the charging/discharging station 16 also is performed (step S204 of FIG. 3). For example, the preparation of the spare EV 2 is performed by charging the spare EV 2 with the charging station 12 when the supply power of the multiple charging stations 12 and the charging/discharging station 16 is less than the contract demand. The preparation of the spare EV 2 may be, for example, placing the EV 2 that is precharged at another apparatus, etc., at a prescribed position inside the facility. The operation of preparing the spare EV 2 may be, for example, any operation such that a precharged EV 2 can be promptly connected to the charging/discharging station 16.

The processing of steps S205 and S206 of FIG. 3 is similar to the processing of steps S104 and 105 described with reference to FIG. 2; and a detailed description is therefore omitted.

In the example, when it is determined that discharge is impossible, the operation of switching the EV 2 connected to the charging/discharging station 16 to the precharged spare EV 2 is performed (step S207 of FIG. 3).

As a result, in the example, even when the capacity of the power storage device 2a of the EV 2 connected to the charging/discharging station 16 becomes insufficient due to being discharged, the supply to the multiple DC/DC power supply circuits 14 of the power from the power storage device 2a of the EV 2 connected to the charging/discharging station 16 can be continued by switching to the spare EV 2.

For example, the EV 2 that is detached from the charging/discharging station 16 is used as the next spare EV 2, and is precharged using the charging station 12, etc., when there is ample margin in the power demand (the processing of step S204 of FIG. 3). As a result, the inability to supply the power to the multiple DC/DC power supply circuits 14 side due to insufficient capacity can be more appropriately suppressed. The spare EV 2 is not limited to one; multiple spare EVs 2 may be prepared. Insufficient capacity can be more reliably suppressed thereby.

The operations of the multiple DC/DC power supply circuits 14 may be controlled so that the supply power of the multiple charging stations 12 is less than the contract demand during the period of switching to the spare EV 2. However, for example, the contract demand is determined based on the average demand power over a 30-minute period, etc.; and the contract demand is not increased immediately when much power is used temporarily. Accordingly, when the switching to the spare EV 2 is completed in a short period of time, the multiple EVs 2 that are connected to the multiple charging stations 12 may be charged with power that temporarily exceeds the contract demand without controlling the operations of the multiple DC/DC power supply circuits 14.

For example, in a configuration that uses a stationary storage battery, there is a possibility that the capacity of the storage battery may undesirably become insufficient when a state of high power demand continues for a long period of time, etc. Although it also may be considered to increase the storage battery capacity beforehand to suppress the occurrence of insufficient capacity, there is a risk that increasing the storage battery capacity may undesirably increase the initial cost of the EV charging apparatus.

In contrast, in the EV charging apparatus 10 according to the embodiment, by including the charging/discharging station 16, the supply of the power to the multiple charging stations 12 side can be continued by switching to the spare EV 2 even when insufficient capacity occurs. Accordingly, for example, it is unnecessary to prepare an EV 2 in which a power storage device 2a having an excessively large capacity is mounted, etc.; and the initial cost of the EV charging apparatus 10, etc., can be suppressed. Thus, in the EV charging apparatus 10 according to the embodiment, the switching to the spare EV 2, etc., can be performed, and compared to a configuration that uses a stationary storage battery, the convenience of the EV charging apparatus 10 can be further increased.

Thus, the method for operating the EV charging apparatus 10 may further include a process of preparing the spare EV 2 (e.g., step S204 of FIG. 3), and a process of switching the EV 2 connected to the charging/discharging station 16 to the precharged spare EV 2 when the charge amount of the power storage device 2a of the EV 2 connected to the charging/discharging station 16 reaches or drops below a prescribed value after starting the supply of the power to the multiple DC/DC power supply circuits 14 (e.g., step S207 of FIG. 3).

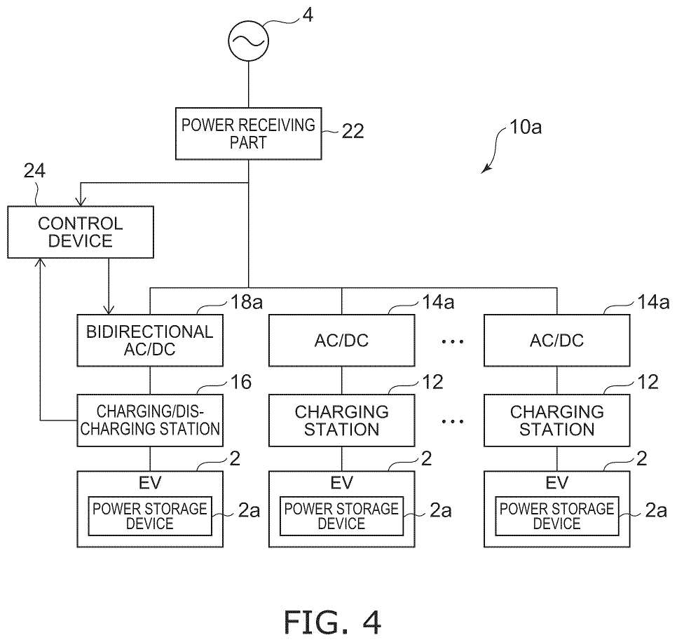

FIG. 4 is a block diagram schematically illustrating a modification of the EV charging apparatus according to the embodiment.

In the EV charging apparatus 10a as illustrated in FIG. 4, the AC/DC power supply circuit 20 is omitted, the DC/DC power supply circuits 14 are replaced with AC/DC power supply circuits 14a (power supply circuits), and the bidirectional DC/DC converter 18 is replaced with a bidirectional AC/DC converter 18a (a bidirectional converter). Components that are substantially the same functionally and configurationally as those of the embodiments described above are marked with the same reference numerals; and a detailed description is omitted.

In the EV charging apparatus 10a, the power receiving part 22 inputs the AC power supplied from the power system 4 to the multiple AC/DC power supply circuits 14a and the bidirectional AC/DC converter 18a.

The multiple AC/DC power supply circuits 14a convert the AC power supplied from the power system 4 side into DC power compatible with the EVs 2, and supply the DC power after the conversion respectively to the multiple charging stations 12. The multiple AC/DC power supply circuits 14a are, for example, AC/DC converters.

The bidirectional AC/DC converter 18a converts the AC power supplied from the power system 4 side into DC power compatible with the EVs 2, and supplies the DC power after the conversion to the charging/discharging station 16. Also, the bidirectional AC/DC converter 18a converts the DC power supplied from the power storage device 2a of the EV 2 connected to the charging/discharging station 16 into AC power compatible with the multiple AC/DC power supply circuits 14a, and supplies the AC power after the conversion to the multiple AC/DC power supply circuits 14a. The bidirectional AC/DC converter 18a is, for example, an AC/DC converter that can perform power conversion in two directions.

Thus, the power that is supplied to the multiple AC/DC power supply circuits 14a and the bidirectional AC/DC converter 18a (the multiple DC/DC power supply circuits 14 and the bidirectional DC/DC converter 18) may be DC power or may be AC power.

Although several embodiments of the invention are described, these embodiments are presented as examples and are not intended to limit the scope of the invention. These novel embodiments may be carried out in other various forms; and various omissions, substitutions, and modifications can be performed without departing from the spirit of the invention. Such embodiments and their modifications are within the scope and spirit of the invention and are included in the invention described in the claims and their equivalents.

### REFERENCE SIGNS LIST

2 EV (electric vehicle), 2a power storage device, 4 power system, 10,10a EV charging apparatus, 12 charging station, 14 DC/DC power supply circuit, 14a AC/DC power supply circuit, 16 charging/discharging station, 18 bidirectional DC/DC converter, 18a bidirectional AC/DC converter, 20 AC/DC power supply circuit, 22 power receiving part, 24 control device

1. An EV charging apparatus, comprising:
a plurality of charging stations respectively connected detachably with EVs, the plurality of charging stations being configured to charge power storage devices mounted in the EVs when connected;
a plurality of power supply circuits configured to convert power supplied from a power system side into direct current power compatible with the EVs, and to supply the direct current power after the conversion respectively to the plurality of charging stations;
a charging/discharging station connected detachably with the EV, the charging/discharging station being configured to charge and discharge the power storage device mounted in the EV when connected;
a bidirectional converter configured to perform power conversion in two directions, the two directions being a direction of charging the power storage device of the EV connected to the charging/discharging station, and a direction of discharging the power storage device of the EV connected to the charging/discharging station, the bidirectional converter being configured to
convert, in the power conversion in the charging direction, the power supplied from the power system side into the direct current power compatible with the EVs, and supply the direct current power the after conversion to the charging/discharging station, and
convert, in the power conversion in the discharging direction, direct current power supplied from the power storage device of the EV connected to the charging/discharging station into power compatible with the plurality of power supply circuits, and supply the power after the conversion to the plurality of power supply circuits.

2. The EV charging apparatus according to claim 1, further comprising:
a control device configured to control an operation of the bidirectional converter,
the control device being configured to acquire information of an amount of electricity received from the power system,
when a supply power of the plurality of charging stations based on the information of the amount of electricity received from the power system is not less than a contract demand, the control device preventing the supply power of the plurality of charging stations from exceeding the contract demand by operating the bidirectional converter in the discharging direction to supply a direct current power stored in the power storage device of the EV connected to the charging/discharging station to the plurality of power supply circuits.

3. The EV charging apparatus according to claim 2, wherein
when a supply power of the plurality of charging stations and the charging/discharging station based on the information of the amount of electricity received from the power system is less than the contract demand, the control device operates the bidirectional converter in the charging direction to charge the power storage device of the EV connected to the charging/discharging station.

4. A method for operating an EV charging apparatus,
the EV charging apparatus including:
a plurality of charging stations respectively connected detachably with EVs, the plurality of charging stations being configured to charge power storage devices mounted in the EVs when connected;
a plurality of power supply circuits configured to convert power supplied from a power system side into direct current power compatible with the EVs, and to supply the direct current power after the conversion respectively to the plurality of charging stations;
a charging/discharging station connected detachably with the EV, the charging/discharging station being configured to charge and discharge the power storage device mounted in the EV when connected;
a bidirectional converter configured to perform power conversion in two directions, the two directions being a direction of charging the power storage device of the EV connected to the charging/discharging station, and a direction of discharging the power storage device of the EV connected to the charging/discharging station, the bidirectional converter being configured to
convert, in the power conversion in the charging direction, the power supplied from the power system side into the direct current power compatible with the EVs, and supply the direct current power after the conversion to the charging/discharging station, and
convert, in the power conversion in the discharging direction, direct current power supplied from the power storage device of the EV connected to the charging/discharging station into power compatible with the plurality of power supply circuits, and supply the power after the conversion to the plurality of power supply circuits,
the method comprising:
connecting the EV to the charging/discharging station; and
when a supply power of the plurality of charging stations is not less than a contract demand, preventing the supply power of the plurality of charging stations from exceeding the contract demand by operating the bidirectional converter in the discharging direction to supply a direct current power stored in the power storage device of the EV connected to the charging/discharging station to the plurality of power supply circuits.

5. The method for operating the EV charging apparatus according to claim 4, further comprising:
preparing a spare EV among the EVs; and
after starting a supply of power to the plurality of power supply circuits, and when a charge amount of the power storage device of the EV connected to the charging/discharging station reaches or drops below a prescribed value, switching the EV connected to the charging/discharging station to the spare EV,
the spare EV being precharged.
